(19) United States
(12) Patent Application Publication
(10) Pub. No.: US 2014/0109531 A1
(43) Pub. Date: Apr. 24, 2014

(54) METHOD AND APPARATUS FOR HORSE BLANKET

(71) Applicant: Patricia Jasin, Toms River, NJ (US)

(72) Inventor: Patricia Jasin, Toms River, NJ (US)

(21) Appl. No.: 13/656,981

(22) Filed: Oct. 22, 2012

(51) Int. Cl. B68C 5/00; B23P 17/04; A44B 11/25

(52) U.S. Cl. 54/79.2; 24/593.1; 29/428

(57) ABSTRACT

An apparatus including a horse blanket, a first strap having a first end attached to the horse blanket, and a first loop, a second strap having a first end attached to the horse blanket, and a second loop, a first device, and a second device, wherein the first device and the second device are configured to be connected together to secure the horse blanket to a horse. The first device having a T shaped portion connected to a first substantially oval ring portion, wherein the first substantially oval ring portion has a first gap to attach or detach the first device from the first strap. The second device having an L shaped portion connected to a second substantially oval ring portion, wherein the second substantially oval ring portion has a second gap in the second substantially oval ring portion to attach or detach the second device from the second strap.

### FIELD OF THE INVENTION

This invention relates to improved methods and apparatus concerning horse blankets

### BACKGROUND OF THE INVENTION

Most horses are turned out from their stalls with a blanket or sheet. These can be insulated, rainproof, fly proof or a combination depending on the time of year and weather. The blanket covers the horse from the neck to their tail, and along the sides of the horse down to the belly. The blanket is secured in the front of the horse by buckles, straps, snaps or ties attached to the front of the blanket. They are locked or tied together at the chest of the horse to keep the blanket on the horse. Some blankets are made with a solid fabric front, and they are put on the horse by slipping it over his head. The sides of the blanket are kept on by surcingle straps. The back of the blanket is kept down by a tail strap which goes under the horse's tail and elastic leg straps, which loosely go under each of the back legs of the horse. There are two surcingle straps, generally made of seatbelt type webbing and width. One side of each strap is sewn onto one and the same side of the horse blanket. The other “loose” end of this surcingle strap has sewn on a piece of hardware. This piece of hardware locks onto another piece of hardware sewn on the opposite side of the blanket. The two surcingle straps are generally crisscrossed under the horse's belly, and the hardware locked into the other hardware to secure the blanket. The locking is not permanent, and typically these surcingle straps come undone.

Because horses roll, kick, run, jump and play, the surcingle straps and/or hardware gets bent, torn, lost, or rusty. This can cause the blanket to fall off or slide, and present a danger to the horse because it could injure itself.

In an emergency situation, where the horse owner does not have a replacement blanket, they resort to tying, or pinning the torn strap. There is no emergency repair kit for surcingle straps and hardware that is fast, easy, no sew, no pin.

### SUMMARY OF THE INVENTION

One or more embodiments of the present invention provide a repair kit for surcingle straps and hardware that requires no sewing, can be used by anyone with little or no horse blanket knowledge, can fix a torn strap in minutes, and can be used as a whole or in parts as needed.

In at least one embodiment, an apparatus is provided which includes a horse blanket, a first strap having a first end attached to the horse blanket, and a second end, opposite the first end of the first strap, wherein the second end of the first strap has a first loop. The apparatus may also include a second strap having a first end attached to the horse blanket, and a second end, opposite the first end of the second strap, wherein the second end of the second strap has a second loop. The apparatus may further include a first device, and a second device; wherein the first device and the second device are configured to be connected together to secure the horse blanket to a horse

The first device may have a T shaped portion connected to a first substantially oval ring portion, wherein the first substantially oval ring portion has a first gap in the first substantially oval ring portion through which the first strap is configured to pass to attach the first device to the first strap or detach the first device from the first strap at the first loop of the first strap.

The second device may have an L shaped portion connected to a second substantially oval ring portion, wherein the second substantially oval ring portion has a gap in the second substantially oval ring portion through which a second strap is configured to pass to attach the second device to the second strap or detach the second device from the second strap at the second loop of the second strap.

The apparatus may further include a third strap having a first end attached to the horse blanket, and a second end, opposite the first end of the third strap, wherein the second end of the third strap has a third loop. The apparatus may further include a fourth strap having a first end attached to the horse blanket, and a second end, opposite the first end of the fourth strap, wherein the second end of the fourth strap has a fourth loop. The apparatus may also include a third device, and a fourth device, wherein the third device and the fourth device are configured to be connected together to secure the horse blanket to a horse;

The third device may have a T shaped portion connected to a third substantially oval ring portion, wherein the third substantially oval ring portion has a third gap in the third substantially oval ring portion through which the third strap is configured to pass to attach the third device to the third strap or detach the third device from the third strap at the third loop of the third strap.

The fourth device may have an L shaped portion connected to a fourth substantially oval ring portion, wherein the fourth substantially oval ring portion has a gap in the fourth substantially oval ring portion through which a fourth strap is configured to pass to attach the fourth device to the fourth strap or detach the fourth device from the fourth strap at the fourth loop of the fourth strap.

The horse blanket may have a top side, a bottom side, a left side, and a right side, wherein the top side is substantially parallel to the bottom side, wherein the left side is substantially parallel to the right side and wherein the top side and the bottom side are substantially perpendicular to the right side and the left side. The first strap may be connected at its first end to the horse blanket and the second strap is connected at its first end to the horse blanket so that the first strap and the second strap are directed towards each other, are untwisted, and connect the left side of the horse blanket with the right side of the horse blanket when the first device is connected to the first loop, the second device is connected to the second loop, and the first device is connected to the second device.

The third strap may be connected at its first end to the horse blanket and the fourth strap may be connected at its first end to the horse blanket so that the third strap and the fourth strap are directed towards each other, are untwisted, and connect a portion of the top side of the horse blanket with another portion of the top side of the horse blanket when the third device is connected to the third loop, the fourth device is connected to the fourth loop, and the third device is connected to the fourth device.

In at least one embodiment, an apparatus is provided including a first strap, a first device for forming a loop from the first strap and for connecting the loop to a first end of a second strap, and a second device having a T shaped portion connected to a first substantially oval ring portion, wherein the first substantially oval ring portion has a first gap in the first substantially oval ring portion through which the first strap is configured to pass to attach the second device to the loop of the first strap or detach the second device from the loop of the first strap. The apparatus may further include a third device; wherein the third device has an L shaped portion connected to a second substantially oval ring portion, wherein the second substantially oval ring portion has a second gap in the second substantially oval ring portion through which the first strap is configured to pass to attach the second device to the loop of the first strap or detach the second device from the loop of the first strap. The apparatus may further include a horse blanket, wherein the second strap has a second end which is fixed to the horse blanket.

In yet another embodiment, a method is provided which may include attaching a first device to a first loop located at a first end of a first strap, wherein a second end of the first strap is connected to a horse blanket; attaching a second device to a second loop located at a first end of a second strap, wherein a second end of the second strap is connected to the horse blanket; and connecting the first device and the second device together to secure the horse blanket to a horse. The first device for a method of at least one embodiment, may have a T shaped portion connected to a first substantially oval ring portion, wherein the first substantially oval ring portion has a first gap in the first substantially oval ring portion through which the first strap is configured to pass to attach the first device to or detach the first device from the first loop of the first strap. The second device for a method of at least one embodiment, may have an L shaped portion connected to a second substantially oval ring portion, wherein the second substantially oval ring portion has a gap in the second substantially oval ring portion through which a second strap is configured to pass to attach the second device to or detach the second device from the second loop of the second strap.

The method may further include disconnecting the first device from the second device; and detaching the first device from first loop of the first strap. The method may further include detaching the second device from second loop of the second strap.

The method may further include attaching a third device to a third loop at a first end of a third strap, wherein a second end of the third strap is connected to the horse blanket, attaching a fourth device to a fourth loop at a first end of a fourth strap, wherein a second end of the fourth strap is connected to the horse blanket, and connecting the third device and the fourth device together to secure the horse blanket to the horse.

In yet another embodiment, a method is provided including using a first device to form a first loop from a first strap; connecting the first device to a first end of a second strap; and attaching a second device to the first loop; wherein a second end of the second strap, opposite the first end of the second strap, is connected to a horse blanket. The method may further include using a third device to form a second loop from a third strap, connecting the third device to a first end of a fourth strap, and attaching a fourth device to the second loop; wherein a second end of the fourth strap, opposite the first end of the fourth strap, is connected to a horse blanket.

### BRIEF DESCRIPTION OF THE DRAWINGS

FIG. 1A shows a front, right, top perspective view of a first prior art device for use with a horse blanket;

FIG. 1B shows a rear, left, top perspective view of the first prior art device of FIG. 1A;

FIG. 10 shows a front, right, bottom perspective view of the first prior art device of FIG. 1A;

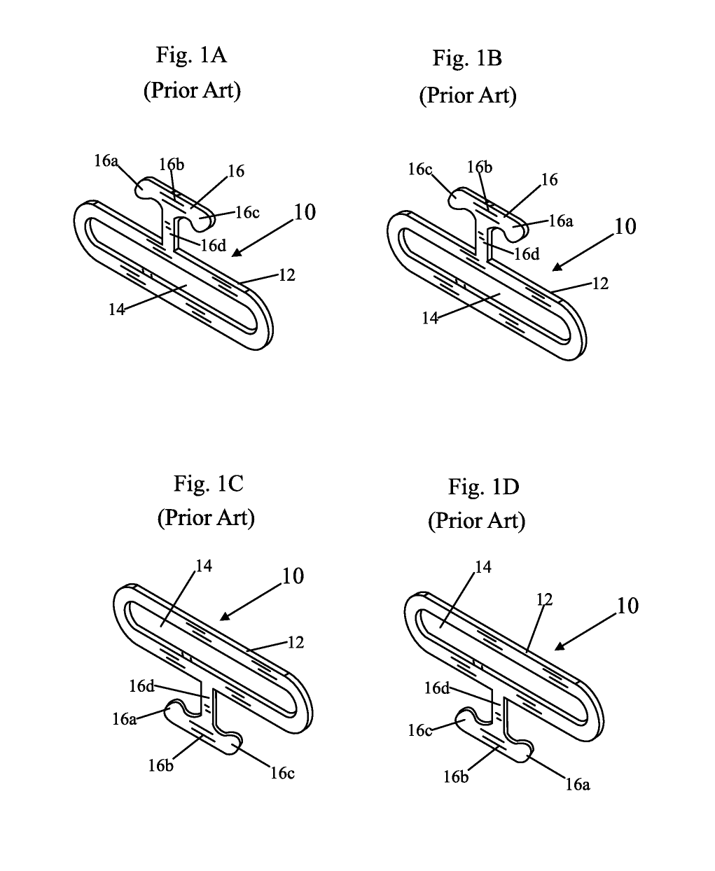

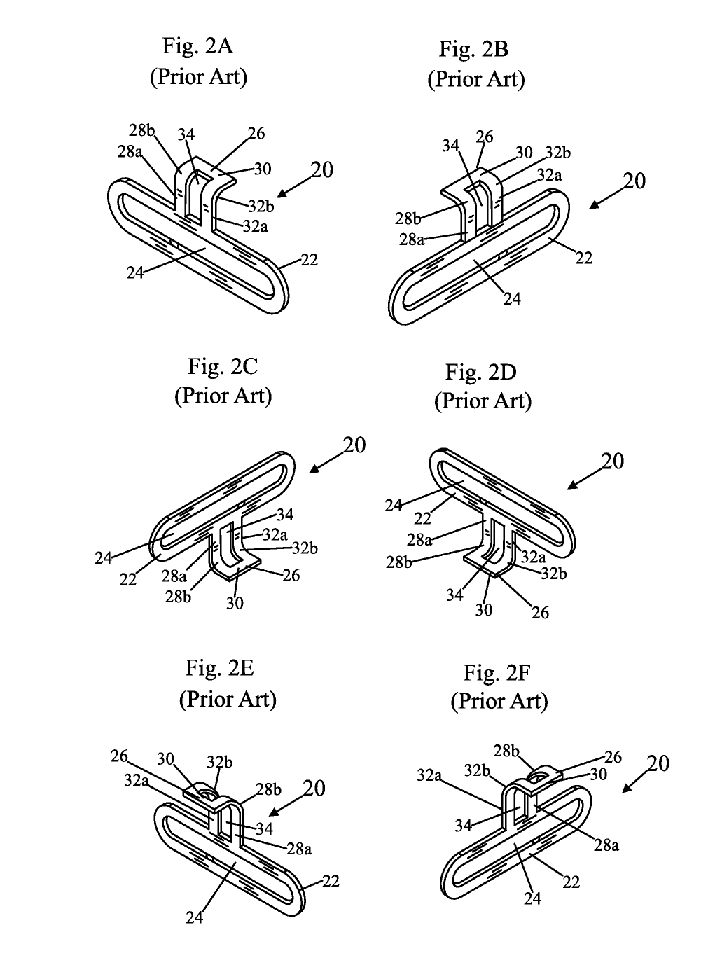

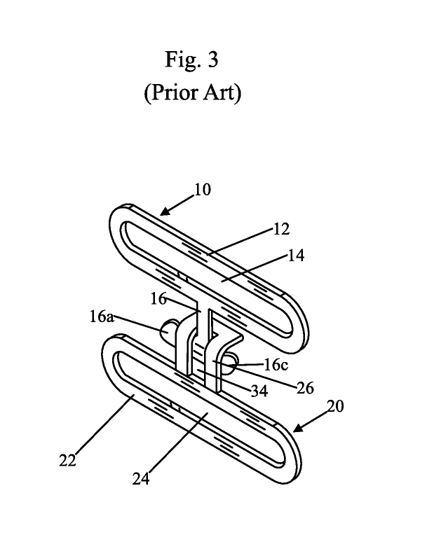

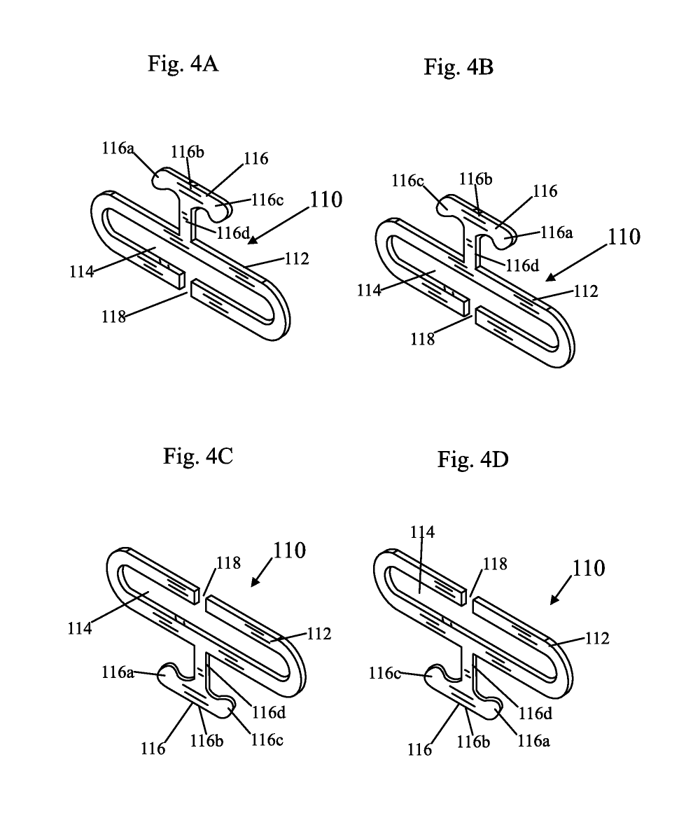

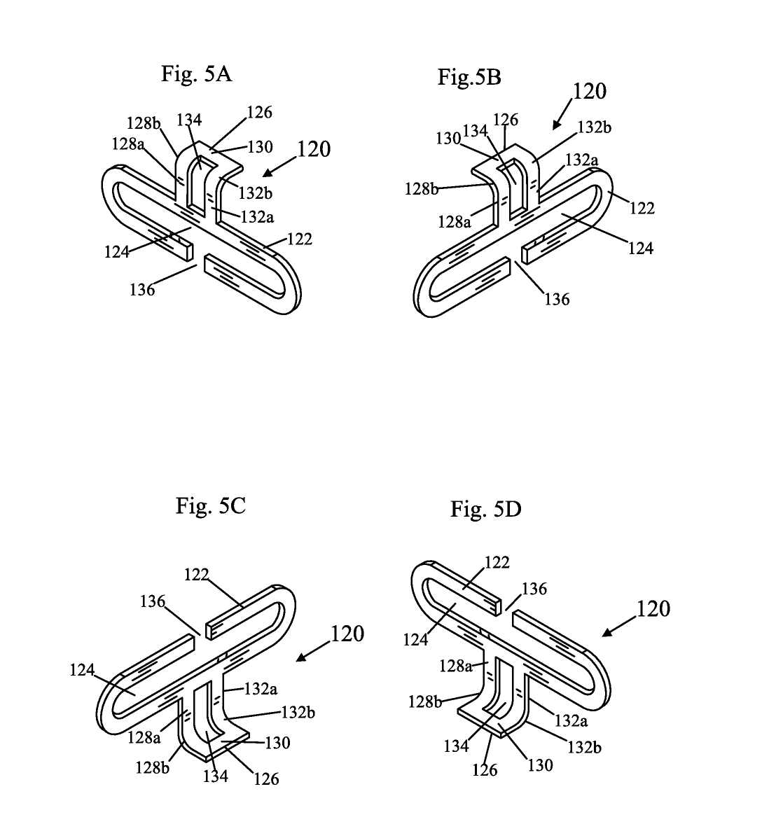

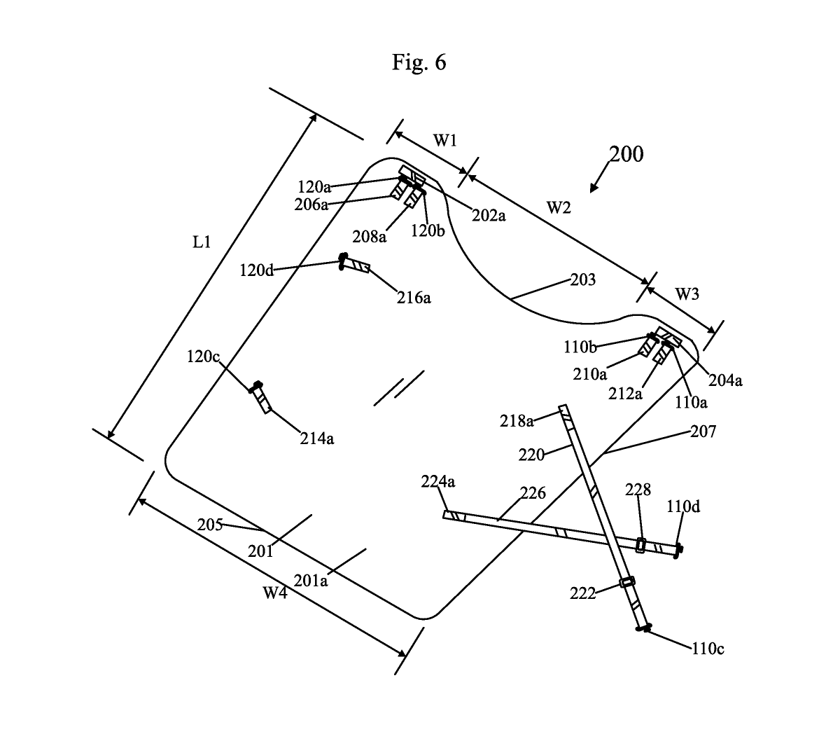

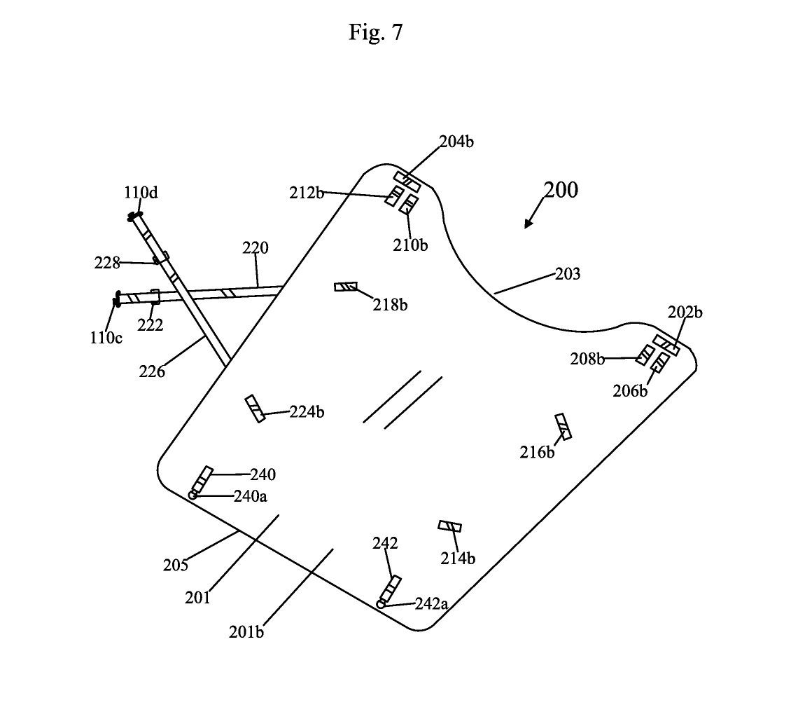

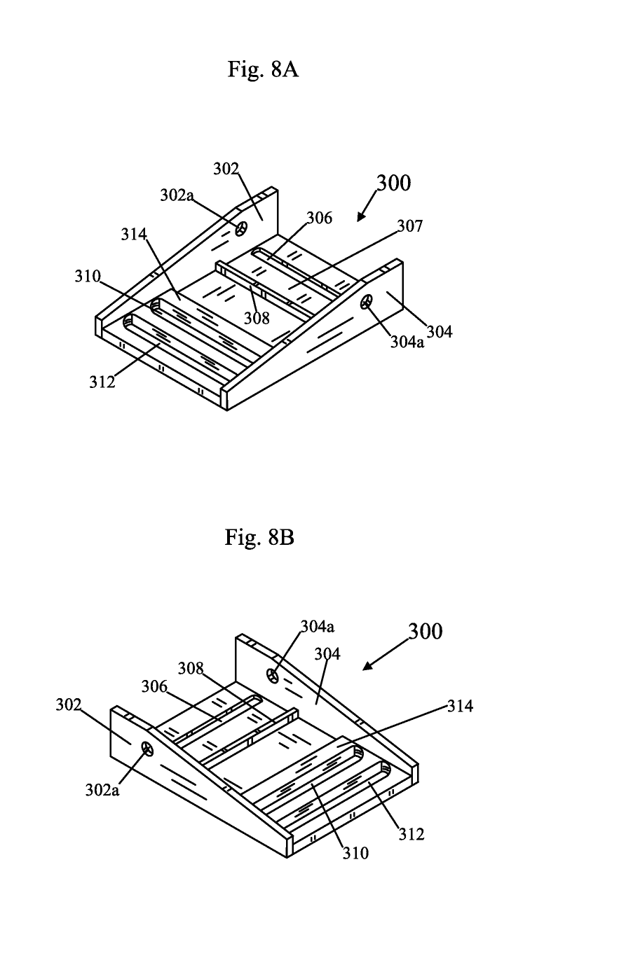

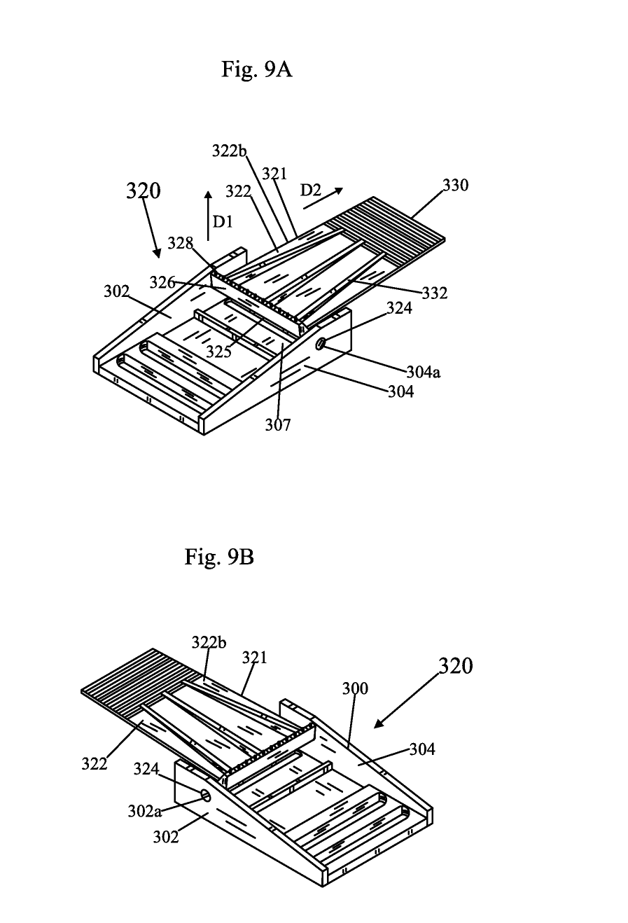

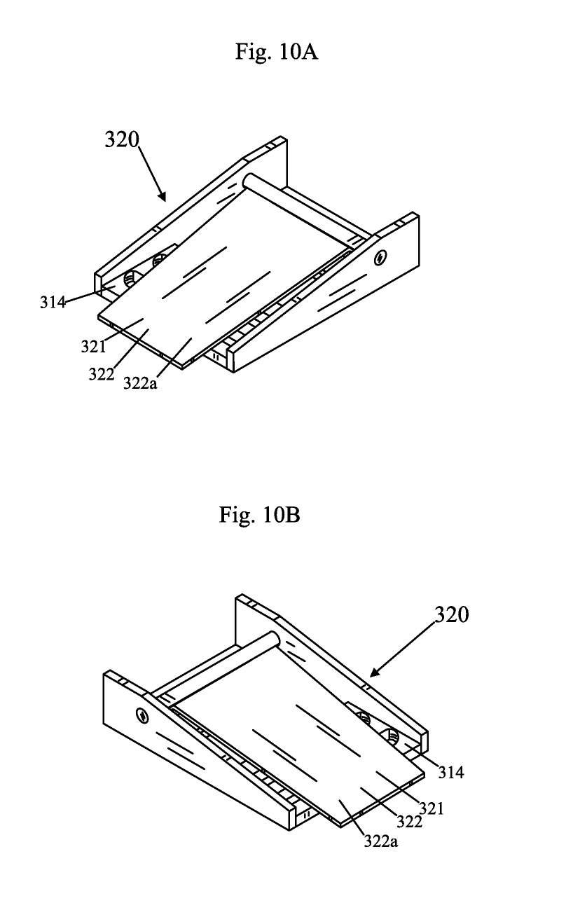

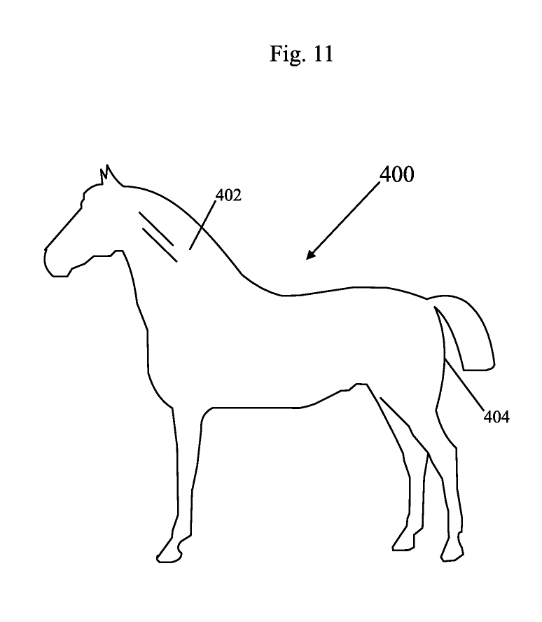

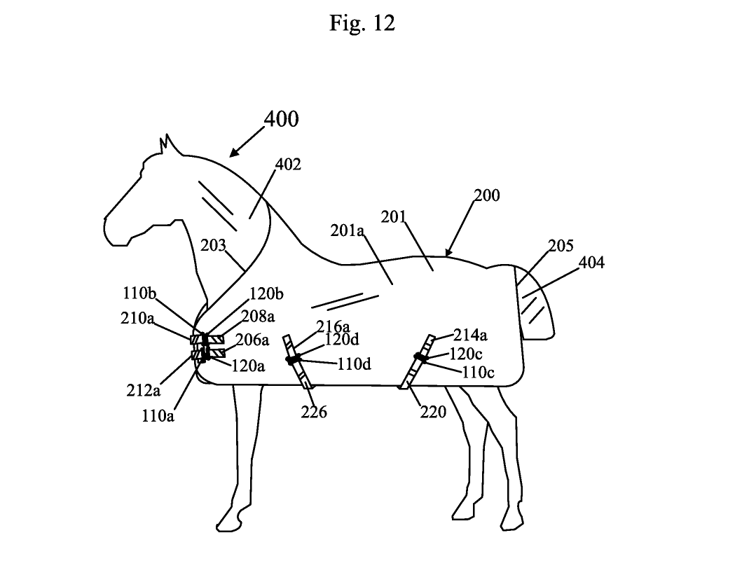

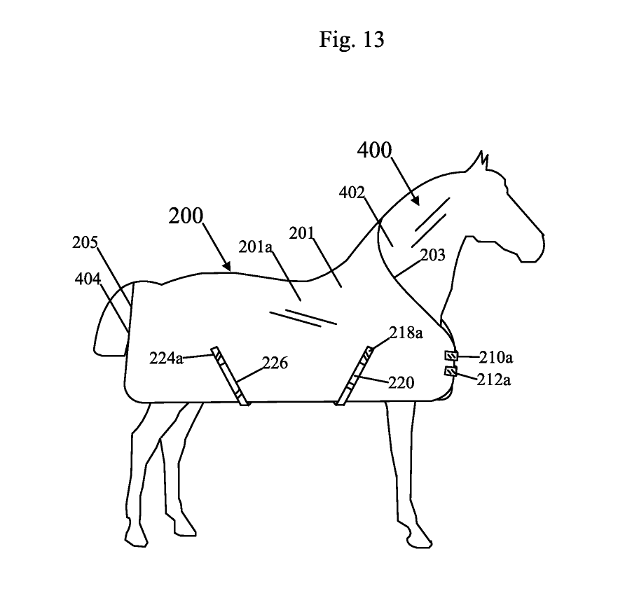

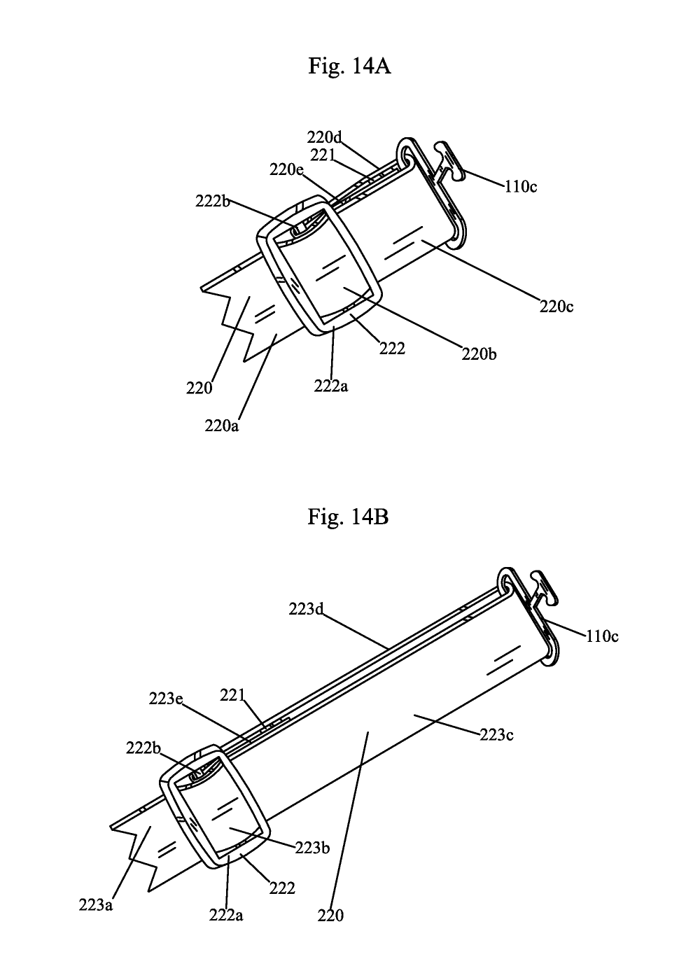

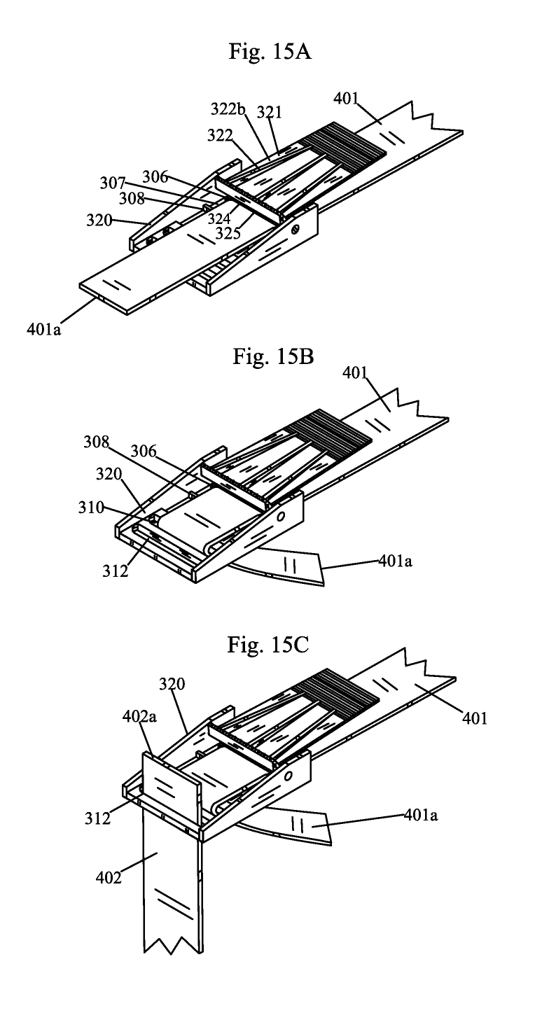

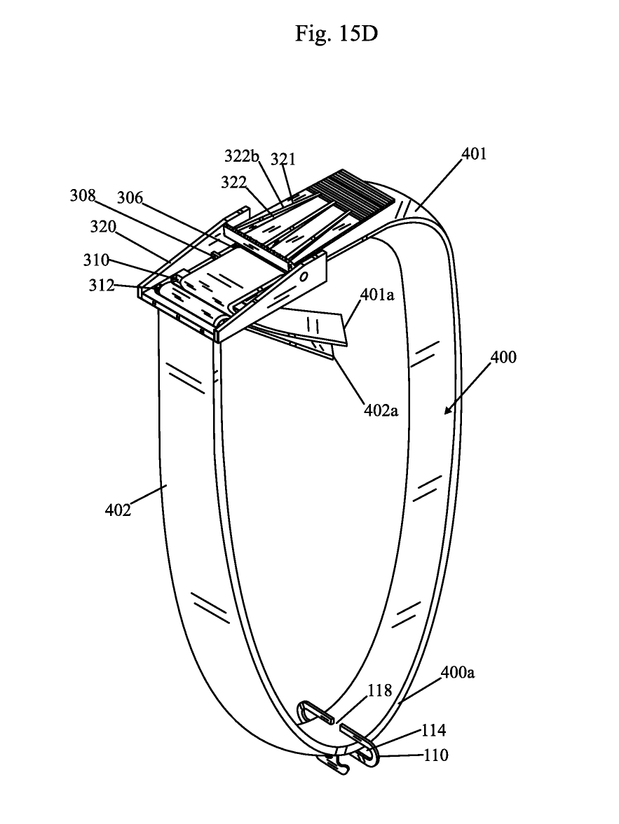

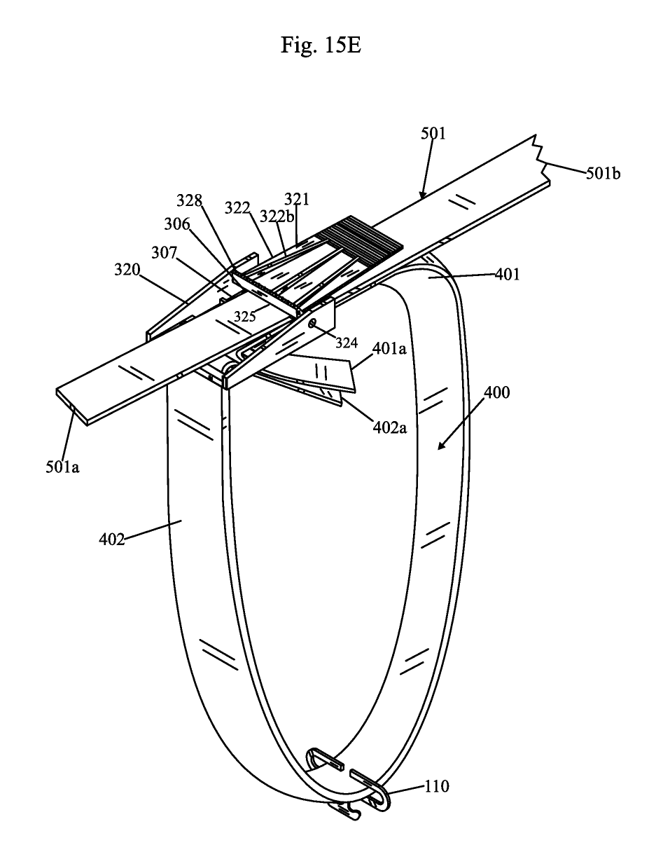

FIG. 1D shows a front, left, bottom perspective view of the first prior art device of FIG. 1A;

FIG. 2A shows a front, right, top perspective view of a second prior art device for use with a horse blanket;

FIG. 2B shows a front, left, top perspective view of the second prior art device of FIG. 2A;

FIG. 2C shows a rear, left, bottom perspective view of the second prior art device of FIG. 2A;

FIG. 2D shows a rear, right, bottom perspective view of the second prior art device of FIG. 2A;

FIG. 2E shows a rear, left, top perspective view of the second prior art device of FIG. 2A;

FIG. 2F shows a rear, right top perspective view of the second prior art device of FIG. 2A;

FIG. 3 shows the first prior art device of FIG. 1A connected to the second prior art device of FIG. 2A;

FIG. 4A shows a front, right, top perspective view of a first device in accordance with an embodiment of the present invention, for use with a horse blanket;

FIG. 4B shows a rear, left, top perspective view of the first device of FIG. 4A;

FIG. 4C shows a front, right, bottom perspective view of the first device of FIG. 4A;

FIG. 4D shows a front, left, bottom perspective view of the first device of FIG. 4A;

FIG. 5A shows a front, right, top perspective view of a second device in accordance with an embodiment of the present invention for use with a horse blanket;

FIG. 5B shows a front, left, top perspective view of the second device of FIG. 5A;

FIG. 5C shows a rear, left, bottom perspective view of the second device of FIG. 5A;

FIG. 5D shows a rear, right, bottom perspective view of the second device of FIG. 5A;

FIG. 6 shows a top view of an apparatus in accordance with an embodiment of the present invention;

FIG. 7 shows a bottom view of the apparatus of FIG. 7;

FIG. 8A shows a front, top, right perspective view of a portion of a clamp, cam, or connecting device for use with an embodiment of the present invention;

FIG. 8B shows a front, top, left perspective view of the portion of the connecting device of FIG. 8A;

FIG. 9A shows a front, top, right perspective view of a clamp, cam, or connecting device for use with an embodiment of the present invention, which includes the portion of FIG. 8A, with the connecting device shown in an open state;

FIG. 9B shows a front, top, left perspective view of the connecting device of FIG. 9A, which includes the portion of FIG. 8A, with the connecting device shown in an open state;

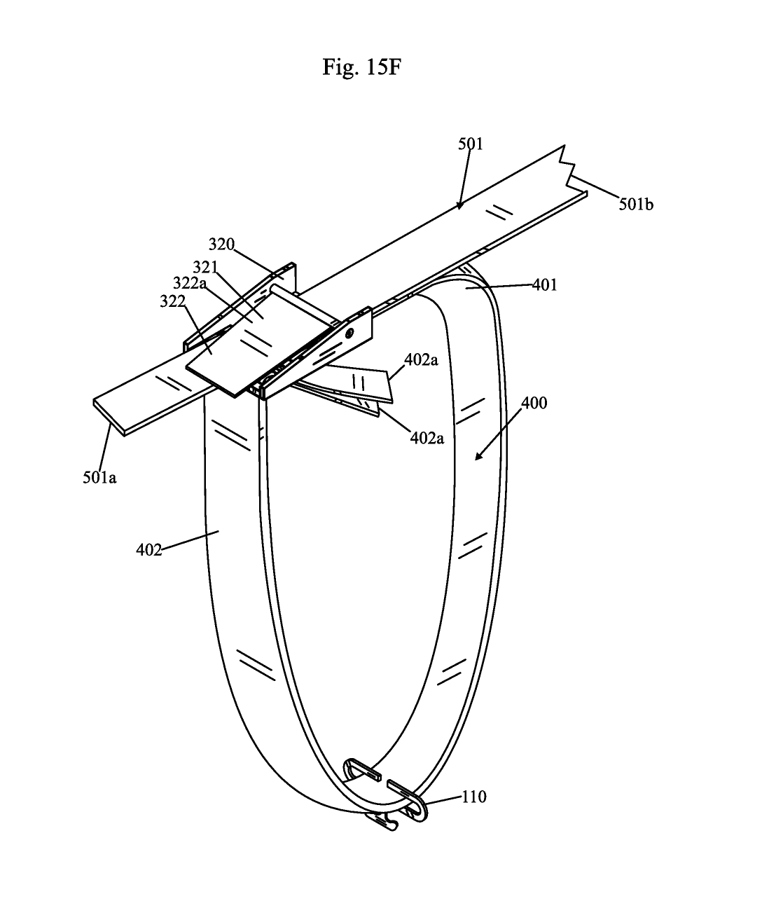

FIG. 10A shows a front, top, right perspective view of the connecting device of FIG. 9A, with the connecting device shown in a closed state;

FIG. 10B shows a front, top, left perspective view of the connecting device of FIG. 9A, with the connecting device shown in an closed state;

FIG. 11 shows a right side view of a horse;

FIG. 12 shows a right side view of the horse, with the apparatus of FIG. 6 placed on the horse, and attached to the horse;

FIG. 13 shows a left side view of the horse, with the apparatus of FIG. 6 placed on the horse, and attached to the horse;

FIG. 14A shows a perspective view of a strap, a buckle, and an attachment device for use with the apparatus of FIG. 6, in a first state;

FIG. 14B shows a perspective view of the strap, the buckle, and the attachment device of FIG. 14A, in a second state;

FIG. 15A shows a front, top, right perspective view of a first portion of a first strap inserted through a first opening of the connecting device of FIG. 9A;

FIG. 15B shows a front, top, right perspective view of the first portion of the first strap of FIG. 15A inserted through the first opening and through a second opening of the connecting device of FIG. 9A;

FIG. 15C shows a a front, top, right perspective view of the first portion of the first strap of FIG. 15A inserted through the first opening and through the second opening of the connecting device of FIG. 9A, and a second portion of the first strap of FIG. 15A inserted through a third opening of the connecting device of FIG. 9A;

FIG. 15D shows a front, top, right perspective view of the first portion of the first strap of FIG. 15A inserted through the first opening and through the second opening of the connecting device of FIG. 9A, and a second portion of the first strap of FIG. 15A inserted through the third opening and through a fourth opening of the connecting device of FIG. 9A;

FIG. 15E shows the configuration of FIG. 15D and in addition, shows a portion of a second strap inserted through a space between a lid device of the connecting device of FIG. 9A, and also shows the device of FIG. 4A attached to the first strap; and

FIG. 15F shows the configuration as in FIG. 15E, with the exception that the connecting device is now shown in a closed state.

### DETAILED DESCRIPTION OF THE DRAWINGS

FIG. 1A shows a front, right, top perspective view of a first prior art device 10 for use with a horse blanket. FIG. 1B shows a rear, left, top perspective view of the first prior art device 10. FIG. 10 shows a front, right, bottom perspective view of the first prior art device 10. FIG. 1D shows a front, left, bottom perspective view of the first prior art device 10.

The first prior art device 10 may be made entirely of a hard metal, such as steel. The first prior art device 10 may include an oval or substantially oval section 12, which has an elongated opening or slot 14. The first prior art device 10 may include a “T” shaped portion 16 having a stem section 16d, a central section 16b, and protruding rounded sections 16a and 16c.

FIG. 2A shows a front, right, top perspective view of a second prior art device 20 for use with a horse blanket. FIG. 2B shows a front, left, top perspective view of the second prior art device 20. FIG. 2C shows a rear, left, bottom perspective view of the second prior art device 20. FIG. 2D shows a rear, right, bottom perspective view of the second prior art device 20. FIG. 2E shows a rear, left, top perspective view of the second prior art device 20. FIG. 2F shows a rear, right top perspective view of the second prior art device 20.

The second prior art device 20 may be made entirely of a hard metal, such as steel. The first prior art device 20 may include an oval or substantially oval section 22, which has an elongated opening or slot 24. The second prior art device 20 may include an “L” shaped portion 26 having straight sections 28a and 32a, curved sections 28b and 32b, straight section 30, and an L-shaped opening 34.

FIG. 3 shows the first prior art device 10 connected to the second prior art device 20 of FIG. 2A. In order to connect device 10 with device 20, the oval sections 12 and 22 are placed perpendicular or substantially perpendicular to each other, and while oval sections 12 and 22 are perpendicular or substantially perpendicular to each other, the protrusions 16a and 16c if the “T” shaped section 16 of the device 10 are inserted through the opening 34 of the device 20. After both protrusions 16a and 16c pass through the opening 34, the oval section 12 is rotated with respect to the oval section 22 so that sections 22 and 12 are parallel or substantially parallel to each other, as shown in FIG. 3. In the state of FIG. 3, the protrusions 16a and 16c prevent the devices 10 and 20 from disconnecting from each other, unless the oval sections are rotated with respect to each other, such as by rotating the oval section 12 until it is substantially perpendicular with respect to the oval section 22.

FIG. 4A shows a front, right, top perspective view of a first device 110 in accordance with an embodiment of the present invention, for use with a horse blanket. FIG. 4B shows a rear, left, top perspective view of the first device 110. FIG. 4C shows a front, right, bottom perspective view of the first device 110. FIG. 4D shows a front, left, bottom perspective view of the first device 110.

The first device 110 has a substantially oval section 112 having a slot or opening 114, however the substantially oval section 112 has a gap 118. The gap 118 allows a strap, such as a horse blanket strap to be inserted through the gap 118 to attach the first device 110 to a strap. The first device 110 may be made entirely of a hard metal, such as steel. The first device 110 may include a “T” shaped portion 116 having a stem section 116d, a central section 116b, and protruding rounded sections 116a and 116c.

FIG. 5A shows a front, right, top perspective view of a second device 120 in accordance with an embodiment of the present invention for use with a horse blanket. FIG. 5B shows a front, left, top perspective view of the second device 120. FIG. 5C shows a rear, left, bottom perspective view of the second device 120. FIG. 5D shows a rear, right, bottom perspective view of the second device 120.

The second device 120 has a substantially oval section 122 having a slot or opening 124, however the substantially oval section 122 has a gap 136. The gap 136 allows a strap, such as a horse blanket strap to be inserted through the gap 136 to attach the second device 120 to a strap.

The second device 120 may be made entirely of a hard metal, such as steel. The second prior art device 120 may include an “L” shaped portion 126 having straight sections 128a and 132a, curved sections 128b and 132b, straight section 130, and an L-shaped opening 134.

The first device 110 and the second device 120 can be connected together in the same manner that the device 10 and 20 are connected together as described with respect to the FIG. 3.

FIG. 6 shows a top view of an apparatus 200 in accordance with an embodiment of the present invention. FIG. 7 shows a bottom view of the apparatus 200.

The apparatus 200 may include a body portion 201. The body portion 201 may be made of cloth and/or a combination of cloth and other materials typically used for a horse blanket. The body portion 201 by itself may be referred to as a horse blanket, or a combination of one or more components including body portion 201 and other components may be referred to as a horse blanket. The apparatus further attachment devices 202a and 204a. Attachment device 202a may be made of a Velcro (trademarked) material, such as hooks and/or loops, and attachment device 204a may be made of a Velcro (trademarked) material, such as hooks and/or loops, so that the attachment devices 202a and 204a couple together and hold together in the form of mating Velcro (trademarked) hooks and/or loops sections.

The apparatus 200 further includes straps 206a, 208a, 210a, 212a, 214a, and 216a, which are inserted through a slot and connected thereby to devices 120a, 120b, 110b, 110a, 120c, and 120d. Each of devices 120a-d may be identical to the device 120 shown in FIGS. 5A-5D, and each of the straps 206a, 208a, 214a, and 216a may be connected to its device (identical to 120) by inserting an end of the strap through a slot identical to slot 124 and by then attaching that end to another part of the respective strap to form a loop. Each of devices 110a-b may be identical to the device 110 shown in FIGS. 4A-4D, and each of the straps 210a and 212a may be connected to its device (identical to 110) by inserting an end of the strap through a slot identical to slot 114 and by then attaching that end to another part of the respective strap to form a loop. The straps 206a, 208a, 210a, 212a, 214a, and 216a are fixed to the body portion 201.

The apparatus 200 further includes straps 220 and 226 which are sewn or otherwise attached at portions or ends 218a and 224a to the body portion 201. One end of each of the straps 220 and 226 is threaded or inserted through buckles or clips 222 and 228 respectively, then inserted through slots in devices 110c and 110d, then threaded back through buckles 222 and 228, and then attached to a portion of strap 220 and 226, respectively, as shown for strap 222 by FIGS. 14A and 14B.

The buckles 222 and 228 can be slid to allow the distance of the devices 110c and 110d from the ends 218a and 224a to be adjusted. Each of the devices 110c and 110d may be identical to the device 110 shown in FIGS. 4A-4D.

Referring to FIG. 6, the body portion 201 has a curved end 203 and a straight end 205. The body portion 201 may have a length L1, which may be about seventy-eight inches. The body portion 201 may have a width W4 on the straight end 205, which may be about sixty-two inches. The body portion 201 may have a width W1 which may be about eighteen inches, a width W2 which may be about forty-two inches, and width W3 which may be about eighteen inches. The widths W1+W2+W3 may be about seventy-eight inches, which is typically greater that the width W4 of about sixty-two inches, for example, on the opposing side, to allow the apparatus 200 to fit more comfortably on the horse 400.

FIG. 7 shows straps or sections 202b, 204b, 206b, 208b, 210b, 212b, 214b, 216b, 218b, and 224b which are connected to straps or sections 202a, 204a, 206a, 208a, 210a, 212a, 214a, 216a, 218a, and 224a, respectively, shown in FIG. 6, through the body portion 201 to securely connect these straps or sections to the body portion 201.

The apparatus 200 includes straps 240 and 242 shown in FIG. 7 which are connected to rings 240a and 242a. The rings 240a and 242a can be connected together at the rear end of a horse, such as the rear end 404 of the horse 400 in FIG. 12.

FIG. 8A shows a front, top, right perspective view of a portion 300 of a clamp, cam, or connecting device 320 (shown in FIG. 9A) for use with an embodiment of the present invention. FIG. 8B shows a front, top, left perspective view of the portion 300. The portion 300 may be made of a hard plastic material. The portion 300 includes walls 302 and 304, which are substantially parallel or parallel to each other, and floor or bottom 307, which is perpendicular or substantially perpendicular to the walls 302 and 304. There is an elongated slot or opening 306 in the floor 307. The portion 300 further includes ridge or wall 308 which protrudes outward from floor 307. The portion 300 further includes step 314 which is integrated with the floor 307 and which rises slightly above floor 307. There are elongated openings or slots 310 and 312 through the step 314 and through the floor 307. The are circular openings 302a and 304a in the walls 302 and 304, respectively.

FIG. 9A shows a front, top, right perspective view of the clamp, cam, or connecting device 320 for use with an embodiment of the present invention, which includes the portion 300 of FIG. 8A, with the connecting device 320 shown in an open state. FIG. 9B shows a front, top, left perspective view of the connecting device 320, with the connecting device 320 shown in an open state. FIG. 10A shows a front, top, right perspective view of the connecting device 320, with the connecting device 320 shown in a closed state. FIG. 10B shows a front, top, left perspective view of the connecting device 320, with the connecting device 320 shown in an closed state.

The connecting device 320 includes a lid or closure device 321. The lid or closure device 321 includes a lid 322 having an inner surface 322b shown in FIG. 9A and an outer surface 322a shown in FIG. 10A. The lid or closure device 321 is connected to the portion 300 by an axle or solid cylinder 324 which is inserted in and sits in the openings 302a and 304a, as shown in FIGS. 9A and 9B. The lid or closure device 321 is rotatably mounted to the portion 300 by the axle 324 so that the device 321 can rotate from the open state of FIGS. 9A-B to the closed state of FIGS. 10A-B. The lid or closure device 321 includes a solid portion 326 which may be substantially shaped in the form of a triangular prism. A plurality 328 of protruding members or protruding pins sticks out from the solid portion 326. There is a gap 325 between the combination of the axle 324 and the portion 326 and the floor or bottom 307, so that a strap can be slid between the lid or closure device 321 and the floor or bottom 307 (i.e. above the floor 307 and below the lid or closure device 321. The lid or closure device 321 can then be closed to cause the plurality 328 of pins to be inserted into the strap, which has been inserted, to hold the strap, which has been inserted, in contact with the connecting device 320.

FIG. 11 shows a right side view of a horse 400. The horse 400 has a neck 402 and a rear portion or rear end 404.

FIG. 12 shows a right side view of the horse 400, with the apparatus 200 of FIG. 6 placed on the horse 400, and attached to the horse 400. FIG. 13 shows a left side view of the horse 400, with the apparatus 200 of FIG. 6 placed on the horse 400, and attached to the horse 400. In FIGS. 12 and 13, the apparatus 200 has been placed so that the surface 201b is in contact with the horse 400 and the surface 201a can be seen. In FIGS. 12 and 13, the devices 110b and 120b have been connected together in a manner similar or identical to that shown in and described with reference to FIG. 3. In addition, the devices 110a and 120a, the devices 110d and 120d, and the device 110c and 120c have also been connected together in a manner similar or identical to that shown in and described with reference to FIG. 3. In at least one embodiment, the straps 220 and 226 are crisscrossed underneath the horse 400 to secure the apparatus 200 to the horse 400. In addition, although not shown in FIGS. 12 and 13, the Velcro (trademarked) or hooks and loops mating portions 202a and 204a may be connected together to further secure the apparatus 200 to the horse 400, near the neck 402. Also the rings 240a and 242a shown in FIG. 7, but not shown in FIGS. 12 and 13 may be connected together by a cord, such as by a string, chain or rope, to further secure the apparatus 200 to the horse 400 near the rear end 404.

In at least one embodiment, when the devices 110d and 120d are connected, as in FIG. 12, the straps 216a and 226 are directed towards each other, and are untwisted. Similarly, when the devices 110c and 120c are connected, as in FIG. 12, the straps 214a and 220 are directed towards each other and are untwisted. Similarly, when the devices 120b and 110b are connected as in FIG. 12, the straps 208a and 210a are directed towards each other and are untwisted. Similarly, when the devices 120a and 110a are connected as in FIG. 12, the straps 206a and 212a are directed towards each other and are untwisted. This configuration allows the devices 110d and 120d, 110c and 120c, 120b and 110b, and 120a and 110a, to connect easily, smoothly and in a manner which makes it less likely for the straps 216a, 226, 214a, 220, 208a, 210a, 206a, and 212a to break, since the straps are untwisted, and lie smoothly typically against the body portion 201 and/or against the horse 400.

The horse 400 or other horses may, over the course of time, damage one or more of devices 110b, 120b, 110a, 120a, 120d, 110d, 120c, and 110c. In accordance with at least one embodiment of the present invention, any of the devices 110b, 120b, 110a, 120a, 120d, 110d, 120c, and 110c can be easily slipped off of its strap to disconnect it from the apparatus 200 through its gap, similar or identical to either gap 118 (for devices 110a-d) or gap 136 (for devices 120a-d). For example device 110b, shown in FIG. 12 can be removed or slipped off of strap 210a by pulling the strap 210a through the gap of device 110b (similar or identical to gap 118). After the device 110b is removed, a new device, which may be identical or substantially similar to device 110 may be attached to strap 210a by inserting strap 210a through the gap 118. In this manner, the devices 110a-d and 120a-d can be easily replaced when damaged in accordance with an embodiment of the present invention.

FIG. 14A shows a perspective view of the strap 220, the buckle 222, and an attachment device 110c for use with the apparatus 200 of FIG. 6, in a first state, in which the buckle 222 is closer to the device 110c than in FIG. 14B. FIG. 14B shows a perspective view of the strap 220, the buckle 222, and the attachment device 110c of FIG. 14A, in a second state, in which the buckle 222 is further from the device 110c than in FIG. 14A.

FIGS. 14A and 14B show how distance of the device 110c from an edge 207 of the apparatus 200 can be adjusted. Sliding the buckle 222 away from the device 110c and toward the edge 207 causes the strap 220 to more greatly double up on itself, and reduces the distance of the device 110c from the edge 207. Sliding the buckle 222 closer to the device 110c and away from the edge 207 causes the strap 220 to double up on itself less, and thus increases the distance of the device 110c from the edge 207. The adjustment of the distance of the device 110c from the edge 207 and the adjustment of the device 110d in a similar or identical manner, can be used to adjust for different size horses to provide a tight fit of the apparatus 200 on a horse such as horse 400.

FIG. 15A shows a front, top, right perspective view of a first portion 401 of a first strap 400 (shown in FIG. 15D) having an end 401a inserted through a first opening 306 of the connecting device 320. The end 401a may be threaded or inserted through the back of the connecting device 320, through the opening 306 and through the gap 325 between the axle 324 and the floor or bottom 307.

FIG. 15B shows a front, top, right perspective view of the end 401a of the first portion 401 of the first strap 400 (show in FIG. 15D) inserted through the first opening 306 and then through the second opening 310 of the connecting device 320.

FIG. 15C shows a a front, top, right perspective view of the end 401a of the first portion 401 of the first strap 400 (shown in FIG. 15D) inserted through the first opening 306 and then through the second opening 310 of the connecting device 320, and a second end 402a (opposite the first end 401a) of a second portion 402 of the first strap 400 (shown in FIG. 15D) inserted through a third opening 312 of the connecting device 320.

FIG. 15D shows a front, top, right perspective view of the first end 401a of the first portion 401 of the first strap 400 inserted through the first opening 306 and then through the second opening 310 of the connecting device 320, and a second end 402a (opposite the first end 401a) of the second portion 402 of the first strap 400 inserted through the third opening 312 and then through the opening 310 of the connecting device 320, to form a closed loop. The device 110 may be attached to the closed loop, as shown in FIG. 15D, by inserting an edge 400a of the first strap 400 into the gap 118 of the device 110, and thereby into the slot or opening 114. The device 110 can be removed or detached from the strap 400 by pulling the edge 400a out through the gap or opening 118.

FIG. 15E shows the configuration of FIG. 15D and in addition, shows a portion of a second strap 501, which is separate from the first strap 400, having an end 501a inserted through the gap or space 325 between the axle 324 and the floor 307, and also shows the device 110 attached to the first strap 400. In accordance with an embodiment of the present invention, if, for example, either of straps 226 or 220 shown in FIG. 6 is torn, so that, for example, buckles 222 or 228 are lost or torn off, either of the remaining ends of straps 220 or 226 can be attached to a connecting device 320 as shown in FIG. 15E (with strap portion 501 being the remaining portion of either strap 220 or 226), to allow the remaining end of strap 220 or 226 to be connected to a loop (in this case strap 400 forms a loop) which can be connected to a device 110 (or a device 120 as needed). In this manner, straps which are torn by horses or simply by wear and tear can be replaced. In accordance with an embodiment of the present invention, any strap for apparatus 200, typically which requires a loop for attachment to a device, similar or identical to either device 110 or 120, can be replaced in the manner shown by FIG. 15E.

FIG. 15F shows the configuration as in FIG. 15E, with the exception that the connecting device 320 is now shown in a closed state. In the closed state the plurality 328 of protruding pins indent, impinge, contact, and/or frictionally engage the strap portion 501 and the strap 400 to hold the strap portion 501 and the strap 400 in a fixed position with respect to the connecting device 320.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a horse blanket;
a first strap having a first end attached to the horse blanket, and a second end, opposite the first end of the first strap, wherein the second end of the first strap has a first loop;
a second strap having a first end attached to the horse blanket, and a second end, opposite the first end of the second strap, wherein the second end of the second strap has a second loop;
a first device; and
a second device;
wherein the first device and the second device are configured to be connected together to secure the horse blanket to a horse;
wherein the first device has a T shaped portion connected to a first substantially oval ring portion, wherein the first substantially oval ring portion has a first gap in the first substantially oval ring portion through which the first strap is configured to pass to attach the first device to the first strap or detach the first device from the first strap at the first loop of the first strap; and
wherein the second device has an L shaped portion connected to a second substantially oval ring portion, wherein the second substantially oval ring portion has a gap in the second substantially oval ring portion through which a second strap is configured to pass to attach the second device to the second strap or detach the second device from the second strap at the second loop of the second strap.

2. The apparatus of claim 1 further comprising
a third strap having a first end attached to the horse blanket, and a second end, opposite the first end of the third strap, wherein the second end of the third strap has a third loop;
a fourth strap having a first end attached to the horse blanket, and a second end, opposite the first end of the fourth strap, wherein the second end of the fourth strap has a fourth loop;
a third device; and
a fourth device;
wherein the third device and the fourth device are configured to be connected together to secure the horse blanket to a horse;
wherein the third device has a T shaped portion connected to a third substantially oval ring portion, wherein the third substantially oval ring portion has a third gap in the third substantially oval ring portion through which the third strap is configured to pass to attach the third device to the third strap or detach the third device from the third strap at the third loop of the third strap; and
wherein the fourth device has an L shaped portion connected to a fourth substantially oval ring portion, wherein the fourth substantially oval ring portion has a gap in the fourth substantially oval ring portion through which a fourth strap is configured to pass to attach the fourth device to the fourth strap or detach the fourth device from the fourth strap at the fourth loop of the fourth strap.

3. The apparatus of claim 2 wherein
wherein the horse blanket has a top side, a bottom side, a left side, and a right side, wherein the top side is substantially parallel to the bottom side, wherein the left side is substantially parallel to the right side and wherein the top side and the bottom side are substantially perpendicular to the right side and the left side;
wherein the first strap is connected at its first end to the horse blanket and the second strap is connected at its first end to the horse blanket so that the first strap and the second strap are directed towards each other, are untwisted, and connect the left side of the horse blanket with the right side of the horse blanket when the first device is connected to the first loop, the second device is connected to the second loop, and the first device is connected to the second device; and
wherein the third strap is connected at its first end to the horse blanket and the fourth strap is connected at its first end to the horse blanket so that the third strap and the fourth strap are directed towards each other, are untwisted, and connect a portion of the top side of the horse blanket with another portion of the top side of the horse blanket when the third device is connected to the third loop, the fourth device is connected to the fourth loop, and the third device is connected to the fourth device.

4. An apparatus comprising
a first strap;
a first device for forming a loop from the first strap and for connecting the loop to a first end of a second strap; and
a second device having a T shaped portion connected to a first substantially oval ring portion, wherein the first substantially oval ring portion has a first gap in the first substantially oval ring portion through which the first strap is configured to pass to attach the second device to the loop of the first strap or detach the second device from the loop of the first strap.

5. The apparatus of claim 4 further comprising
a third device; and
wherein the third device has an L shaped portion connected to a second substantially oval ring portion, wherein the second substantially oval ring portion has a second gap in the second substantially oval ring portion through which the first strap is configured to pass to attach the second device to the loop of the first strap or detach the second device from the loop of the first strap.

6. The apparatus of claim 4 further comprising
a horse blanket; and
wherein the second strap has a second end which is fixed to the horse blanket.

7. The apparatus of claim 4 further comprising
a horse blanket; and
wherein the second strap has a second end which is fixed to the horse blanket.

8. A method comprising the steps of
attaching a first device to a first loop located at a first end of a first strap, wherein a second end of the first strap is connected to a horse blanket;
attaching a second device to a second loop located at a first end of a second strap, wherein a second end of the second strap is connected to the horse blanket;
connecting the first device and the second device together to secure the horse blanket to a horse;
wherein the first device has a T shaped portion connected to a first substantially oval ring portion, wherein the first substantially oval ring portion has a first gap in the first substantially oval ring portion through which the first strap is configured to pass to attach the first device to or detach the first device from the first loop of the first strap; and
wherein the second device has an L shaped portion connected to a second substantially oval ring portion, wherein the second substantially oval ring portion has a gap in the second substantially oval ring portion through which a second strap is configured to pass to attach the second device to or detach the second device from the second loop of the second strap.

9. The method of claim 8 further comprising
disconnecting the first device from the second device; and
detaching the first device from first loop of the first strap.

10. The method of claim 8 further comprising
disconnecting the first device from the second device; and
detaching the second device from second loop of the second strap.

11. The method of claim 9 further comprising
detaching the second device from second loop of the second strap.

12. The method of claim 8 further comprising
attaching a third device to a third loop at a first end of a third strap, wherein a second end of the third strap is connected to the horse blanket;
attaching a fourth device to a fourth loop at a first end of a fourth strap, wherein a second end of the fourth strap is connected to the horse blanket;
connecting the third device and the fourth device together to secure the horse blanket to the horse;
wherein the third device has a T shaped portion connected to a third substantially oval ring portion, wherein the third substantially oval ring portion has a third gap in the third substantially oval ring portion through which the third strap is configured to pass to attach the third device to or detach the third device from the third loop of the third strap; and
wherein the fourth device has an L shaped portion connected to a fourth substantially oval ring portion, wherein the fourth substantially oval ring portion has a gap in the fourth substantially oval ring portion through which a fourth strap is configured to pass to attach the fourth device to or detach the fourth device from the fourth loop of the fourth strap.

13. The method of claim 12 wherein
wherein the horse blanket has a top side, a bottom side, a left side, and a right side, wherein the top side is substantially parallel to the bottom side, wherein the left side is substantially parallel to the right side and wherein the top side and the bottom side are substantially perpendicular to the right side and the left side;
wherein the first strap is connected at its second end to the horse blanket and the second strap is connected at its second end to the horse blanket so that the first strap and the second strap are directed towards each other, are untwisted, and connect the left side of the horse blanket with the right side of the horse blanket when the first device is connected to the first loop, the second device is connected to the second loop, and the first device is connected to the second device; and
wherein the third strap is connected at its second end to the horse blanket and the fourth strap is connected at its second end to the horse blanket so that the third strap and the fourth strap are directed towards each other, are untwisted, and connect a portion of the top side of the horse blanket with another portion of the top side of the horse blanket when the third device is connected to the third loop, the fourth device is connected to the fourth loop, and the third device is connected to the fourth device.

14. A method comprising
using a first device to form a first loop from a first strap;
connecting the first device to a first end of a second strap; and
attaching a second device to the first loop;
wherein a second end of the second strap, opposite the first end of the second strap, is connected to a horse blanket.

15. The method of claim 14
wherein the second device has a T shaped portion connected to a first substantially oval ring portion, wherein the first substantially oval ring portion has a first gap in the first substantially oval ring portion through which the first strap is configured to pass to attach the second device to the first loop of the first strap or detach the second device from the first loop of the first strap.

16. The method of claim 14
wherein the second device has an L shaped portion connected to a first substantially oval ring portion, wherein the first substantially oval ring portion has a first gap in the first substantially oval ring portion through which the first strap is configured to pass to attach the second device to the first loop of the first strap or detach the second device from the first loop of the first strap.

17. The method of claim 14 further comprising
using a third device to form a second loop from a third strap;
connecting the third device to a first end of a fourth strap; and
attaching a fourth device to the second loop;
wherein a second end of the fourth strap, opposite the first end of the fourth strap, is connected to a horse blanket.

18. The method of claim 17
wherein the second device has a T shaped portion connected to a first substantially oval ring portion, wherein the first substantially oval ring portion has a first gap in the first substantially oval ring portion through which the first strap is configured to pass to attach the second device to the first loop of the first strap or detach the second device from the first loop of the first strap;
wherein the fourth device has an L shaped portion connected to a second substantially oval ring portion, wherein the second substantially oval ring portion has a second gap in the second substantially oval ring portion through which the third strap is configured to pass to attach the fourth device to the second loop of the third strap or detach the fourth device from the second loop of the third strap;
and wherein the second device is configured to be attached or detached from the fourth device.
